(19) United States
(12) Patent Application Publication
(10) Pub. No.: US 2011/0239520 A1
(43) Pub. Date: Oct. 6, 2011

(54) SINGLE DOSE FISH ATTRACTANT CONTAINER

(76) Inventor: JEFF OSTROM, Lake Oswego, OR (US)

(21) Appl. No.: 12/750,474

(22) Filed: Mar. 30, 2010

(51) Int. Cl. A01K 85/01

(52) U.S. Cl. 43/42.06

(57) ABSTRACT

A hollow container contains a single dose of fish attractant. The container is made from a material which is easily penetratable by a fish hook so that the attractant located in the container can be dispensed from the capsule onto a fishing lure.

### BACKGROUND OF THE INVENTION

It is common for fisherman to place a fish attractant on a fishing lure before the lure is used. These attractants generally come in bottles, tubes, or as a spray, and the container holds multiple doses of attractant which will be used over a relatively long period of time. While such attractants are successful in attracting fish, the attractant can get on the user's hands, on other fishing equipment, and on the container it comes in, which causes those objects to carry the attractant scent and often makes them sticky.

### SUMMARY OF THE INVENTION

The subject invention overcomes the foregoing problems associated with using fish attractants by providing a single dose of attractant in a unitary capsule. The capsule is made from a material that is easily penetratable by a fish hook. This allows the capsule to be pierced and the attractant dispensed onto a fishing lure and the capsule easily disposed of without getting the attractant on the user's hands or other fishing equipment.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a side elevation view, partially broken away to show hidden detail, of a capsule embodying the subject invention.

FIG. 2 is a side elevation view of a smaller sized capsule.

FIG. 3 is a side elevation view of an elongate capsule.

FIG. 4 is a side elevation view of a spherical capsule.

FIGS. 5A-5C are sequence views showing how attractant is dispensed from the capsule onto a lure.

FIG. 6 is a side elevation view of a lure with a capsule embodying the subject invention embedded in it.

FIG. 7 is a side elevation view of a capsule embodying the subject invention placed on a fish hook.

FIG. 8 is a side elevation view of a fishing lure having multiple hooks with capsules embodying the subject invention impaled on them.

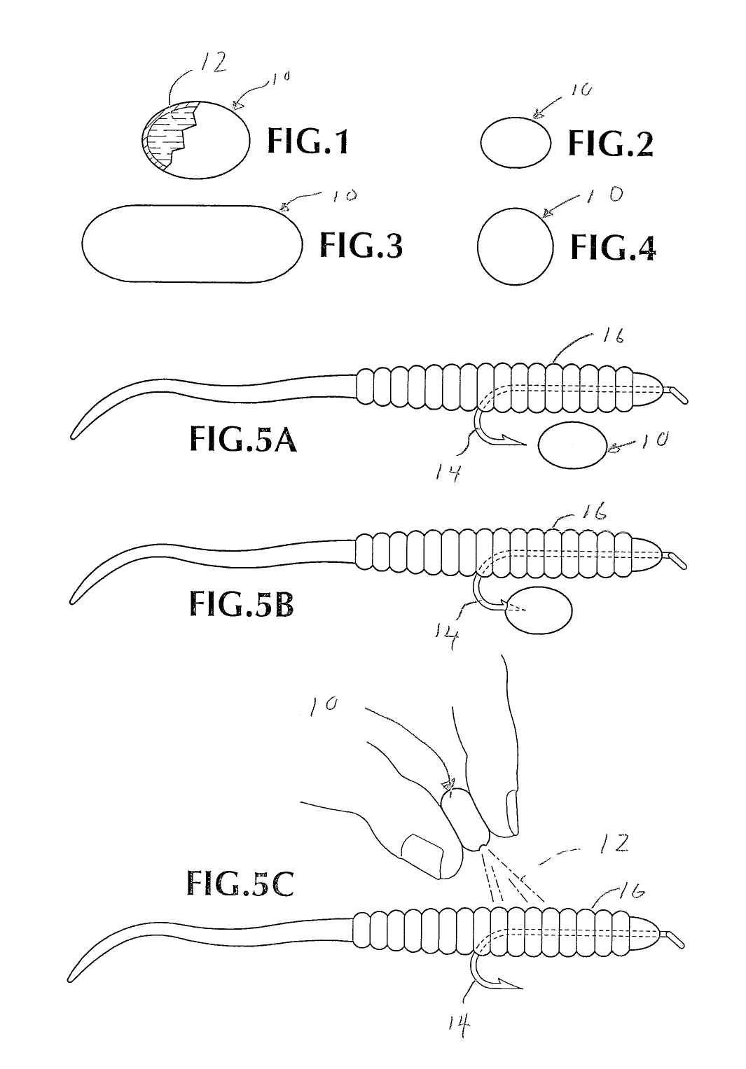

### DETAILED DESCRIPTION OF PREFERRED EMBODIMENTS

Referring now to the drawings, a hollow capsule 10 is filled with an aromatic fluid 12 that acts as an attractant to fish. The capsule preferably is spheroidal, or generally spheroidal, FIG. 2. Depending on its intended use, in some instances the capsule might be quite elongate, FIG. 3, and in other instances it might be spherical, FIG. 4. The size of the capsule depends on the particular fish that is being fished for. The fluid 12 located in the capsule can be any of a number of commercially available fish attractants and preferably it is oil based. However, in some situations, a water based attractant might be utilized. The capsule preferably is a unitary shell and it is made from a material that can be pierced easily with a fish hook. The material preferably is a water soluble material, but one that takes several minutes to dissolve. As a result, it is totally biodegradable and does not have to be kept and disposed of later, but can simply be discarded into the water. Different colors can be used for capsules carrying different scents as a way of determining which scent is in a particular capsule. Capsules of the foregoing type are commonly used to deliver medicines and are commonly referred to as soft shell capsules, or more particularly as soft gelatin capsules.

The capsules can be used in several ways. The most common way is shown in FIGS. 5A-5C. The hook 14 of a lure 16 is used to penetrate the capsule 10, FIGS. 5A and 5B. The capsule is then squeezed to dispense the attractant 12 onto the lure, FIG. 5C. The capsule is then discarded without any of the attractant being spilled. When used in this manner, the capsule is sized to hold a single dose of attractant 12 which is suitable for covering the lure 16 it will be used in conjunction with. This allows the user to carry multiple single attractant doses, each in a separate sealed container which is clean and does not have any residual attractant on it. As a result , the attractant can be applied to a lure without it getting on the user's hands or other fishing equipment and the depleted capsule can be easily dispensed of without the possibility that attractant will be spilled.

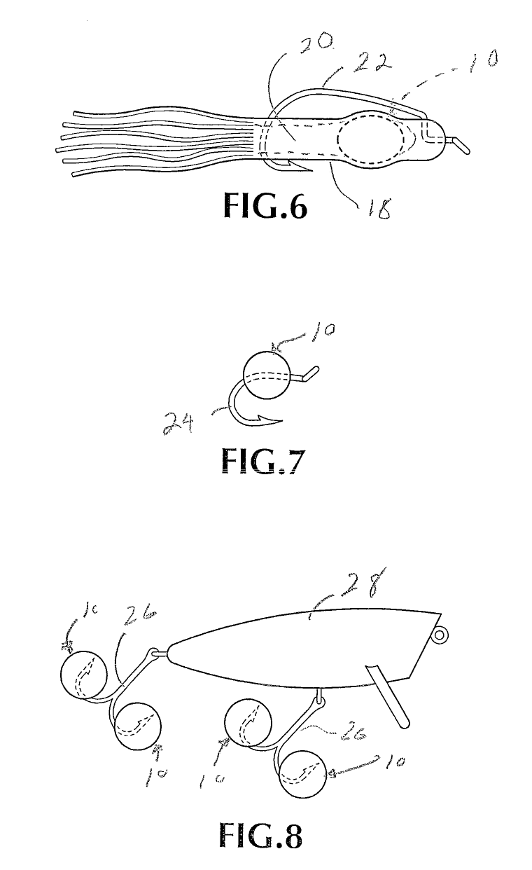

Alternately, with a lure 18 that has a lateral cavity 20, the capsule 10 can be pierced with the hook 22 on the lure and then placed in the cavity 20, FIG. 6. The attractant will leak out of the cavity as the lure is being used over a period of time. After the attractant has been depleted and the lure retracted, the capsule can be removed from the cavity 20 and discarded.

In another embodiment, the capsule 10 is cylindrical with a diameter similar to a specific type of fish egg. The capsule is placed on the hook 24 in the same manner that the corresponding fish egg would be placed on the hook. When the attractant has been depleted, the capsule is removed from the hook and discarded. In this situation, the capsule would have the same color as a corresponding fish egg and the attractant would simulate the scent of a fish egg, FIG. 7.

In a final embodiment, shown in FIG. 8, multiple capsules of the type that correspond to a fish egg are placed on the hooks of a lure that has multiple hooks 26, like the plug 28. Again, when the attractant has been depleted from the capsules, the capsules can be removed from the hooks and discarded.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A single dose container of fish attractant comprising:
(a) a hollow capsule;
(b) said capsule being easily penetratable by a fishing hook; and
(c) an aromatic fluid having a scent which will attract fish is located within said capsule.

2. The container of claim 1 wherein said capsule is made from a water soluble material.

3. The container of claim 1 wherein said capsule is a soft shell capsule.

4. The container of claim 1 wherein said capsule is a soft gelatin capsule.

5. The container of claim 1 wherein said capsule is spheroidal.

6. The container of claim 1 wherein said capsule is spherical.

7. The container of claim 1 wherein said aromatic fluid is oil based.

8. A method for placing an attractant on a fishing lure, comprising:
(a) filling a hollow capsule with an aromatic fluid having a scent which will attract fish;
(b) penetrating said capsule and depositing said aromatic fluid on a fishing lure; and
(c) using said lure for fishing after said aromatic fluid has been placed on said lure.

9. The method of claim 8 wherein said capsule is a water soluble soft gelatin capsule.

10. The method of claim 8 wherein said capsule is penetratable with a fish hook.

11. The method of claim 8 wherein after said capsule is penetrated, said capsule is squeezed to dispense said material onto said lure.

12. The method of claim 8 wherein said capsule is penetrated by placing it on a fish hook.

13. The method of claim 8 wherein said capsule is spheroidal and has a diameter similar to that of a fish egg.

14. The method of claim 8 wherein after said capsule is penetrated, it is inserted into a cavity located in said lure.

15. The method of claim 8 wherein said capsule is penetrated by placing it on a hook which is attached to a lure.
